(19) United States
(12) Patent Application Publication
(10) Pub. No.: US 2014/0191491 A1
(43) Pub. Date: Jul. 10, 2014

(54) Suspension Fork

(71) Applicants: Dirk Lüde, Bad Wiessee (DE); Jürgen Beier, Ulm (DE)

(72) Inventors: Dirk Lüde, Bad Wiessee (DE); Jürgen Beier, Ulm (DE)

(73) Assignee: GUSTAV MAGENWIRTH GMBH & CO KG, BAD URACH (DE)

(21) Appl. No.: 13/698,791

(22) PCT Filed: May 18, 2011
(86) PCT No.: PCT/EP11/58070

§ 371 Date: Sep. 19, 2013

(30) Foreign Application Priority Data
May 19, 2010 (DE) 10 2010 021 076.5

(51) Int. Cl. B62K 25/08

(52) U.S. Cl. CPC B62K 25/08
USPC 280/276

(57) ABSTRACT

The invention relates to a suspension fork (1) having at least one positive chamber (31), at least one negative chamber (32) and an adjusting device (40) for adjusting the length of the suspension fork (1), the adjusting device (40) comprising a valve means (50) which is arranged between the at least one positive chamber (31) and the at least one negative chamber (32), and an actuation device (60),
characterized in that the actuation device (60) has at least one first position for adjusting a short length of the suspension fork (1) (lowered suspension fork) and at least one second position for adjusting a long length of the suspension fork (1) (extended suspension fork).

The invention relates to a suspension fork according to the preamble of claim 1.

Such a suspension fork is known from DE 199 53 901 C2, for example. The suspension fork disclosed therein has a suspension device including a positive chamber and a negative chamber. A communication path is provided between the positive chamber and the negative chamber. Said path can be closed by a shut-off device. In order to fill both chambers, one chamber is filled with compressed air and/or compressed gas via a filling opening and the other chamber via the communication path. Having filled and adjusted the suspension device, the filling opening and the communication path are closed. In order to adjust the suspension device and in particular the length of the suspension fork, the shut-off device can be opened while the filling opening is closed and the adjustment can be made. For example, a lift can be reduced by telescoping the suspension fork and/or a lift can be increased by extending the suspension fork. The shut-off device is closed after the adjustment.

The known suspension fork has the drawback that the adjustment of the suspension fork is complicated and the adjustment of the suspension fork length is not easy. In particular, the difficulty is that for lowering the suspension fork the actuation device must constantly be actuated while the suspension fork is lowered. When the suspension fork has been lowered as desired, the actuation device can be released again. Likewise the actuation device must constantly be actuated to extend the suspension fork and the suspension fork must be relieved at the same time. When the suspension fork has been raised as desired, the actuation device can be released again.

It is therefore the object of the invention to provide a suspension fork with which a reduction in lift can readily be adjusted and which has a simple design.

The object of the invention is achieved with a suspension fork according to the features of claim 1 and/or according to the features of one of the independent claims. Advantageous embodiments of the invention are defined in the dependent claims.

A suspension fork having at least one positive chamber, at least one negative chamber and an adjusting device for adjusting the length of the suspension fork is provided according to the invention, the adjusting device comprising a valve means arranged between the at least one positive chamber and the at least one negative chamber, and an actuation device, the actuation device having at least one first position for adjusting a short length of the suspension fork (lowered suspension fork) and at least one second position for adjusting a long length of the suspension fork (extended suspension fork).

The suspension fork according to the invention has the advantage that when the actuation device is adjusted to the first position, the suspension fork automatically lowers in the suspension direction when loaded and that when the actuation device is adjusted to the second position the suspension fork is automatically extended.

According to the invention, the actuation device can have a locking device for locking the actuation device in the and/or a first position and the and/or a second position.

According to the invention the actuation device can have a locking device for locking the actuation device in the first position and/or the second position.

A suspension fork having at least one positive chamber, at least one negative chamber and an adjusting device for adjusting the length of the suspension fork is also provided according to the invention, the adjusting device comprising a valve means arranged between the at least one positive chamber and the at least one negative chamber, and an actuation device, the actuation device having a locking device for locking the actuation device in the and/or a first position and the and/or a second position.

The adjusting device can have at least two communication paths for connecting the positive chamber with the negative chamber according to the invention.

The adjusting device can have at least two communication paths for connecting the positive chamber with the negative chamber according to the invention.

A suspension fork having at least one positive chamber, at least one negative chamber and an adjusting device for adjusting the length of the suspension fork is also provided according to the invention, the adjusting device comprising a valve means arranged between the at least one positive chamber and the at least one negative chamber, and an actuation device, the adjusting device having at least two communication paths for connecting the positive chamber with the negative chamber.

The adjusting device can be designed and arranged according to the invention so as to connect the positive chamber with the negative chamber via one of the at least two communication paths to adjust a short length of the suspension fork (lowered suspension fork) and to connect the positive chamber with the negative chamber via another one of the at least two communication paths to adjust a long length of the suspension fork (extended suspension fork).

According to the invention, the adjusting device can have an adjusting piston designed so as to open one communication path in the and/or a first position of the actuation device and to open the other communication path in the and/or a second position of the actuation device. Here, the adjusting piston can be slidably arranged in a cylinder which at least partially defines the at least two communication paths between the positive chamber and the negative chamber.

According to the invention, the valve means can have at least one check valve.

The valve means can have at least two check valves according to the invention. Preferably, the two check valves can be arranged in a chamber through which also preferably at least one communication path extends from the positive chamber to the negative chamber. The two check valves of these designs of the invention can have valve closure members, such as balls, which are biased in preferably opposite directions by a spring device. For example, a spring can be arranged between two balls, said spring biasing the two balls into corresponding valve seats.

A suspension fork having at least one positive chamber, at least one negative chamber and an adjusting device for adjusting the length of the suspension fork is also provided according to the invention, the adjusting device comprising a valve means which is arranged between the at least one positive chamber and the at least one negative chamber, and an actuation device, the valve means having at least two check valves.

In the designs of the invention having the at least two communication paths, at least one check valve can be arranged in each of the at least two communication paths between the positive chamber and the negative chamber. Here, the at least two check valves can be designed and arranged such that at least one check valve blocks a flow from the positive chamber to the negative chamber by its non-return function and that at least one check valve blocks a flow from the negative chamber to the positive chamber by its non-return function.

At least one communication path can be arranged between the positive chamber and the negative chamber according to the invention, and the valve means can be designed and arranged such that in the first position of the actuation device the valve means opens the communication path in a first direction and blocks it in the direction opposed to the first direction and that in the second position of the actuation device the valve means opens the communication path in the direction opposed to the first direction and blocks it in the first direction.

A suspension fork having at least one positive chamber, at least one negative chamber and an adjusting device for adjusting the length of the suspension fork is also provided according to the invention, the adjusting device comprising a valve means which is arranged between the at least one positive chamber and the at least one negative chamber, and an actuation device, at least one communication path being arranged between the positive chamber and the negative chamber and the valve means being designed and arranged such that in the first position of the actuation device the valve means opens the communication path in a first direction and blocks it in the direction opposed to the first direction and that in the second position of the actuation device the valve means opens the communication path in the direction opposed to the first direction and blocks it in the first direction.

In this connection, the adjusting device can include an adjusting piston designed such that in the and/or a first position of the actuation device it opens the at least one communication path in the first direction and blocks it in the direction opposed to the first direction and in the and/or a second position of the actuation device it opens the at least one communication path in the direction opposed to the first direction and blocks it in the first direction. In this case, the adjusting piston can be slidably arranged in a cylinder which at least partially defines the at least one communication path between the positive chamber and the negative chamber. Here, a check valve can be designed and arranged in the at least one communication path and the effective direction of the check valve can be reversed by the actuation device. For example, the check valve can be arranged in the adjusting piston substantially perpendicularly and/or perpendicularly to the main axis of the adjusting piston and can be reversed by the actuation of the actuation device with the at least one communication path defined in the adjusting piston between the positive chamber and the negative chamber.

According to the invention, the suspension fork can have an intermediate chamber which is arranged between the positive chamber and the negative chamber with respect to fluid mechanics, at least one communication path being arranged between the negative chamber and the intermediate chamber, in which a valve means is designed and arranged so as to block a flow from the negative chamber into the intermediate chamber while a flow is permitted from the intermediate chamber into the negative chamber.

A suspension fork having at least one positive chamber, at least one negative chamber and an adjusting device for adjusting the length of the suspension fork is also provided according to the invention, the adjusting device comprising a valve means arranged between the at least one positive chamber and the at least one negative chamber, and an actuation device, the suspension fork having an intermediate chamber which is arranged between the positive chamber and the negative chamber with respect to fluid mechanics, at least one communication path being arranged between the negative chamber and the intermediate chamber, in which a valve means is designed and arranged such that a flow is blocked from the negative chamber into the intermediate chamber while a flow is permitted from the intermediate chamber into the negative chamber.

According to the invention, the connection between the negative chamber and the intermediate chamber can be established exclusively via the communication path, which includes the valve means, from a certain lowering extent of the suspension fork. In this connection, the valve means can comprise a check valve which blocks a flow into the intermediate chamber.

According to the invention, the actuation device can have a remote control.

The remote control can here be a radio remote control.

According to the invention, the actuation device and/or the remote control can have a lever.

In the designs of the invention including a remote control, the remote control can have the and/or a locking device for locking the remote control in a first position and a second position.

According to the invention, the adjusting device can have at least one further position where the length of the suspension fork can be adjusted and at least one locked position where the adjustability of the length of the suspension fork is blocked.

According to the invention, the suspension fork can be a pneumatic suspension fork which preferably comprises a compressed air suspension.

The invention is described below by means of the exemplary embodiments shown in the figures.

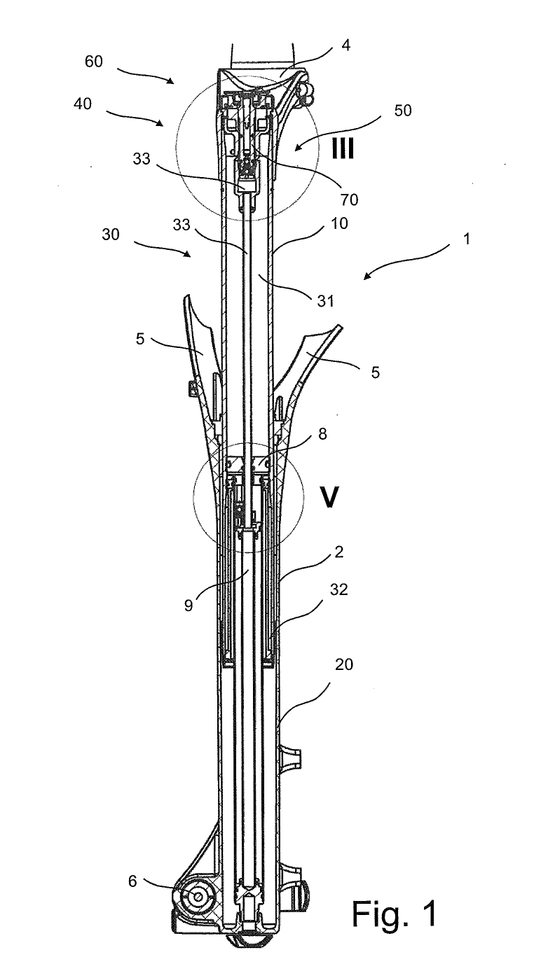

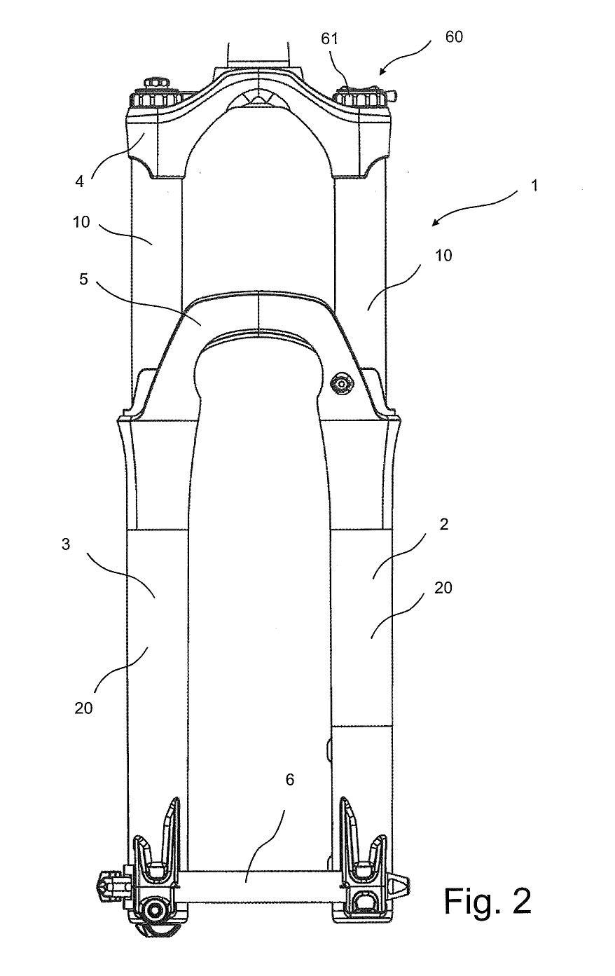

FIG. 1 shows a lateral sectional view of a suspension fork according to a design of the invention along line I-I of FIG. 2, the adjusting device being shown in a first position for adjusting the suspension fork in an extended position.

FIG. 2 shows a front view of the suspension fork of FIG. 1.

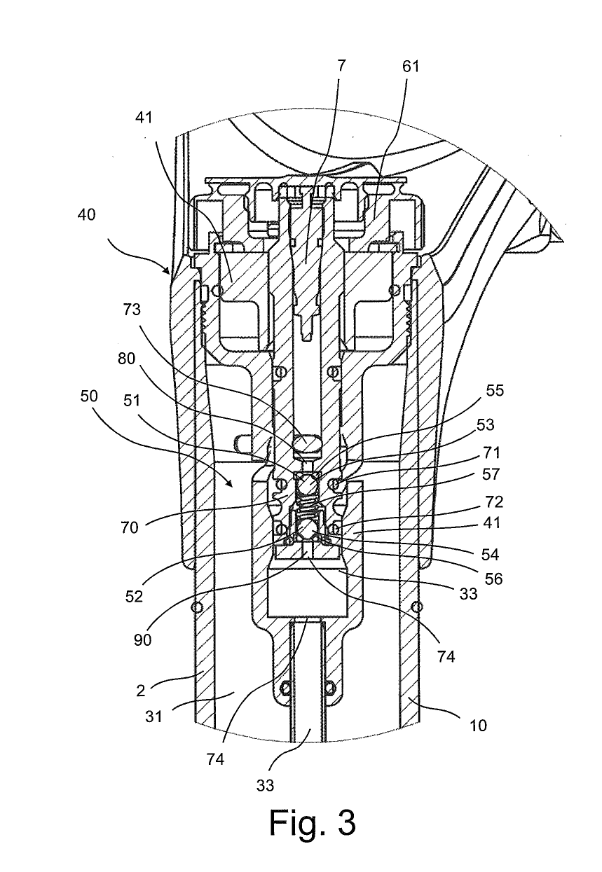

FIG. 3 shows an enlarged detailed view of the region of FIG. 1, which is defined by circle III.

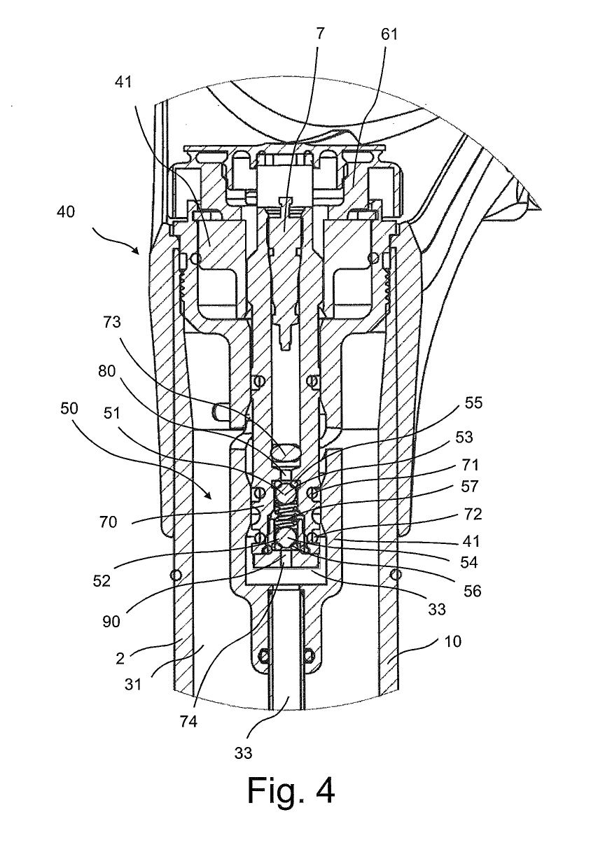

FIG. 4 shows a detailed view of the suspension fork of FIG. 1, which corresponds to FIG. 3, the adjusting device being shown in a second position for adjusting the suspension fork in a lowered and/or retracted position.

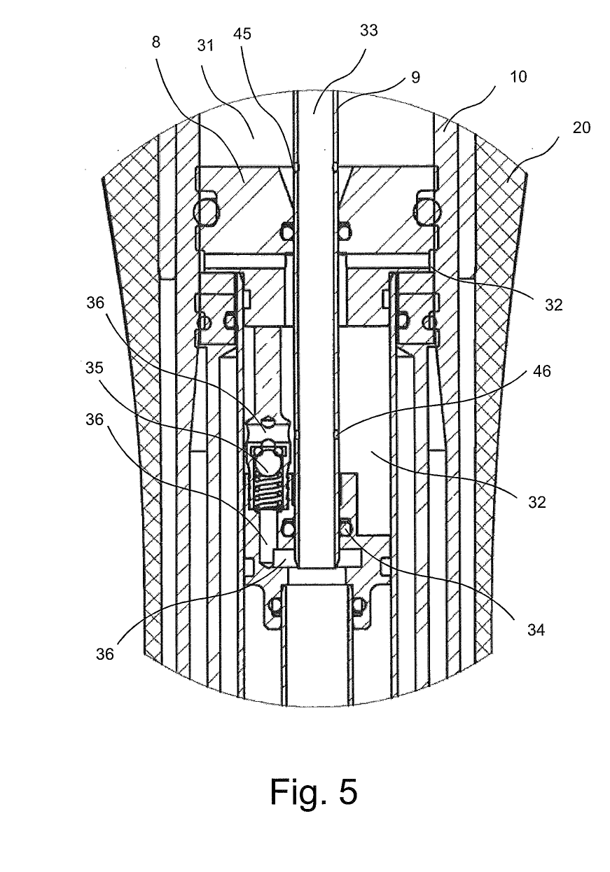

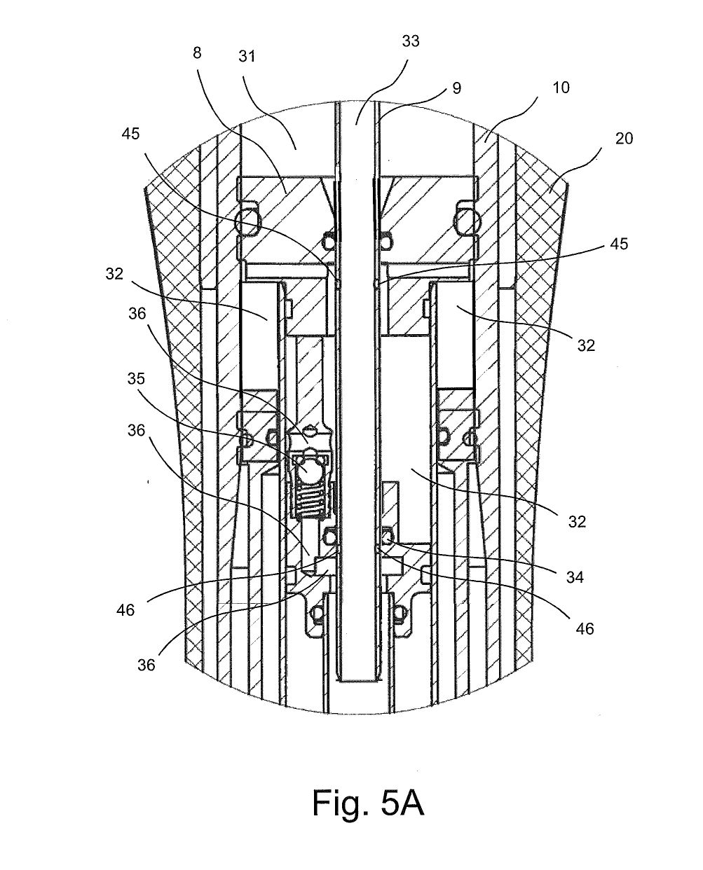

FIG. 5 shows an enlarged detailed view of the region of FIG. 1, which is defined by circle V.

FIG. 5A shows a detailed view of the suspension fork of FIG. 1, which corresponds to FIG. 5, the suspension fork being shown in a more lowered and/or more retracted position.

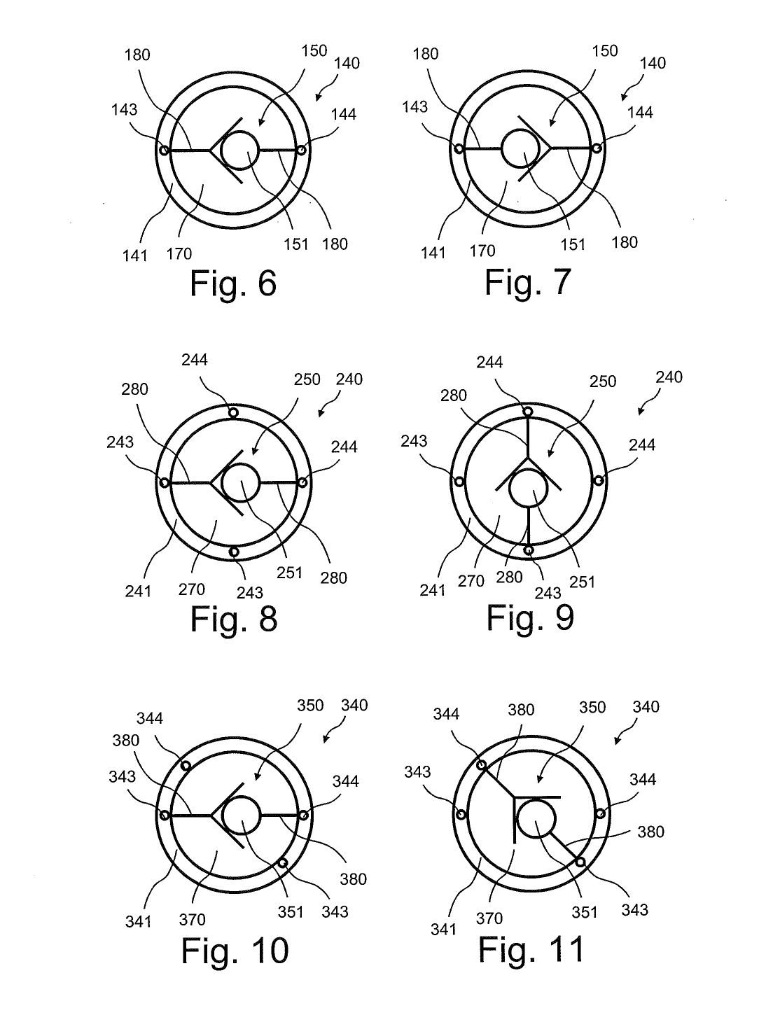

FIG. 6 shows a schematic view of an alternative adjusting device in a first position for adjusting the suspension fork in an extended position.

FIG. 7 shows a view of the adjusting device of FIG. 6, which corresponds to FIG. 6, in a second position for adjusting the suspension fork in a lowered and/or retracted position.

FIG. 8 shows a schematic view of an alternative adjusting device in a first position for adjusting the suspension fork in an extended position.

FIG. 9 shows a view of the adjusting device of FIG. 8, which corresponds to FIG. 8, in a second position for adjusting the suspension fork in a lowered and/or retracted position.

FIG. 10 shows a schematic view of an alternative adjusting device in a first position for adjusting the suspension fork in an extended position.

FIG. 11 shows a view of the adjusting device of FIG. 10, which corresponds to FIG. 10, in a second position for adjusting the suspension fork in a lowered and/or retracted position.

The following reference numerals are used in the description:
1 suspension fork
2 suspension device
3 damper device
4 fork brace
5 stabilizer
6 quick release axle
7 filling valve
8 main piston
9 piston rod
10 stanchion tube
20 sliding tube
30 suspension device
31 positive chamber
32 negative chamber
33 intermediate chamber
34 gasket
35 check valve
36 communication path (between negative chamber and intermediate chamber)
40 adjusting device
40 adjusting device
240 adjusting device
340 adjusting device
41 cylinder
141 cylinder
141 cylinder
141 cylinder
143 connection to the positive chamber
144 connection to the intermediate and/or negative chamber
243 connection to the positive chamber
244 connection to the intermediate and/or negative chamber
343 connection to the positive chamber
344 connection to the intermediate and/or negative chamber
45 connecting bore
46 connecting bore
50 valve means
150 valve means
250 valve means
350 valve means
51 check valve
151 check valve
251 check valve
351 check valve
52 check valve
53 ball
54 ball
55 valve seat
56 valve seat
57 spring
60 actuation device
61 operating knob
70 adjusting piston
170 adjusting piston
270 adjusting piston
370 adjusting piston
71 gasket
72 gasket
73 connecting bore (to positive chamber 31)
74 connecting bore (to intermediate chamber 33)
80 communication path
180 communication path
280 communication path
380 communication path
90 communication path

FIGS. 1 to 5 show a suspension fork according to a first exemplary embodiment of the invention.

The suspension fork 1 has a suspension device 2 and a damper device 3, which are connected with one another via a fork brace 4, a front stabilizer 5 and a rear stabilizer 5. A quick release axle 6 serving for receiving a front wheel (not shown) of a bicycle (not shown) is provided at the dropout of the suspension fork.

The suspension device 2 and the damper device 3 each have a stanchion tube 10 which is fixedly connected with the fork brace 4 and, with respect thereto, a telescopically movable sliding tube 20.

As is evident, the invention is not limited to the suspension fork design as shown. For example, the suspension fork can also be made with sliding tubes immersing in stanchion tubes and/or have fewer or more or no stabilizers.

The suspension device 2 is equipped with a suspension means 30 which has a positive chamber 31, a negative chamber 32 and an intermediate chamber 33. The sliding tube 20 accommodates a main piston 8 which is attached to a piston rod 9. When the suspension fork 1 is compressed, the main piston 8 is inserted in the stanchion tube 10 thus increasing the pressure in the positive chamber 31 and decreasing it in the intermediate chamber 33 and the negative chamber 32.

When the suspension fork is compressed with respect to the basic position (i.e. the equilibrium position which adjusts with the suspension fork after the cyclist got onto the bicycle), the air and/or the gas is compressed in the positive chamber 31 so as to create a suspension effect with a progressive suspension characteristic. In the basic position (i.e. in the adjustment of the suspension characteristics of the suspension fork, which is made by the factory or the cyclist before the ride), the pressure in the positive chamber 31 should be chosen substantially according to the cyclist's weight acting on the suspension fork.

In the rebound of the suspension fork from the basic position, the air and/or the gas in the negative chamber 32 is compressed so as to create a suspension effect having a progressive suspension characteristic. In the basic position, the pressure in the negative chamber 32 should substantially be chosen according to the desired responsiveness of the suspension fork.

As best seen in FIGS. 3 and 4, the valve means 50 has a check valve 51 and a check valve 52, which are disposed in the communication path 80 and communication path 90, respectively, between the positive chamber 31 and the negative chamber 32.

The check valve 51 has a ball 53 and a valve seat 55. The check valve 52 has a ball 54 and a valve seat 56. A spring 57 is arranged between both balls 53, 54. It biases both balls 53, 54 into the corresponding valve seats 55 and 56, respectively.

According to alternative embodiments of the invention, one of the two balls 53, 54 or both balls 53, 54 can be biased into their valve seats by other means known to a person skilled in the art. For example, two springs can be provided in place of the one spring 57. Correspondingly, one or two clips might be provided, for example. Alternatively or in addition, it might also be possible to arrange the balls on screens and/or sponges or in floating fashion. Both balls might also be arranged on the top or bottom when the communication line design is correspondingly adapted.

According to alternative embodiments of the invention, it is possible to replace a ball 53, 54 or both balls 53, 54 with other valve closure members which are known to the person skilled in the art and are in particular suitable for check valves, e.g. cones, cylinders, plates, etc.

In a cylinder 41 of the adjusting device 40, an adjusting piston 70 is slidably arranged which contains the valve means 50. A gasket 71 and a gasket 72 are attached to the adjusting piston 70 so as to connect the intermediate space receiving spring 57 between the balls 53 and 54 in an upper position (see FIG. 3) via a bore in the adjusting piston 70 with the positive chamber 31 and/or in a lower position (FIG. 4) via the same or another bore 74 in the adjusting piston 70 with the intermediate chamber 33 (or with the negative chamber in the case of designs which have no intermediate chamber).

The intermediate chamber 33 communicates with the negative chamber 32 via a valve arrangement shown in more detail in FIG. 5.

The actuation device 60 has an operating knob 61 with which the actuation device 60 adjusts the adjusting device in a first defined position and a second defined position so as to place the adjusting piston 70 in the upper position (FIG. 3) and/or the lower position (FIG. 4).

In the position of FIG. 3, the suspension fork 1 moves into the extended position and/or the suspension fork 1 remains in the extended position. The adjusting piston 70 is here arranged in the cylinder 41 so as to connect the intermediate space receiving spring 57 with the positive chamber 31 via a bore in the adjusting piston 70.

When the suspension fork is in the extended position, the check valve 52 prevents the pressure increasing in the positive chamber 31 during the compression from reaching the intermediate chamber 33 and thus the negative chamber 32. Impacts occurring in the extended position of the suspension fork 1 are cushioned while riding. The suspension fork 1 remains in the extended position.

When the suspension fork is in the lowered position, the pressure in the negative chamber 32 and the intermediate chamber 33 will increase during the rebound. It can then escape via the check valve 52 and the communication path 90 into the intermediate space which receives the spring 57 and via the bore in the adjusting piston into the positive chamber 31 which has a lower pressure. This is continued until the suspension fork is in the extended position.

In the position of FIG. 4, the suspension fork 1 adjusts itself in the lowered position and/or the suspension fork remains in the lowered position. The adjusting piston 70 is here arranged in the cylinder 41 so as to connect the intermediate space which receives the spring 57 with the intermediate chamber 33 and thus with the negative chamber 32 via a bore 74 in the adjusting piston 70.

When the suspension fork is in the lowered position, the check valve 51 prevents the pressure increasing in the negative chamber 32 and thus in the intermediate chamber 33 during the rebound from reaching the positive chamber 31. Impacts occurring in the lowered and/or retracted position of the suspension fork 1 are cushioned while riding. The suspension fork 1 remains in the lowered position.

When the suspension fork 1 is in the extended position, the pressure in the positive chamber 31 will increase during the compression. It can escape via the communication path 80 and the check valve 51 into the intermediate space which receives the spring 57 and then via the bore 74 in the adjusting piston 70 into the intermediate chamber 33 and thus into the negative chamber 32 which has a lower pressure. This is continued until the suspension fork 1 is in the lowered position.

The suspension fork optionally has a safety suspension ensuring that the suspension fork does not bump in the case of full compression in particular when in the lowered and/or retracted position. For this purpose, a mechanical spring, e.g. an elastomer, can be provided at the end of the strut. The preferred solution is a suspension in accordance with the suspension fork disclosed in DE 10 2006 010 245 A1 whose entire disclosure is incorporated into the present disclosure by reference.

FIG. 5 shows the corresponding design of the piston rod. Connecting bores 45 and 46 are provided in the piston rod 8. In a communication path 36 between the negative chamber 32 and the intermediate chamber 33, a check valve 35 is provided which is arranged and designed so as to block a flow from the negative chamber 32 into the intermediate chamber 33 when the negative chamber 32 is only connected with the intermediate chamber 33 via the connecting path 36. When the connecting bores 45 pass over the gasket 34, a volume exchange can only take place from the intermediate chamber 33 into the negative chamber 32 via the check valve 35. The check valve 35 then prevents a flow from the negative chamber 32 into the intermediate chamber 33, thus ensuring that from a certain lowering of the suspension fork (when the connecting bores 34 pass over the gasket 34) the pressure in the negative chamber 32 cannot be decreased by a flow into the intermediate chamber 33. A suspension action of the negative chamber 32 is thus ensured and a mechanical bump is avoided.

In the detailed view of the suspension fork of FIG. 1, which is shown in FIG. 5A and corresponds to FIG. 5, the suspension fork is shown in a more lowered and/or more retracted position. The connecting bore 45 is still above the gasket 34 so that there is a connection between the intermediate chamber and the negative chamber 32. The connecting bores 46 have already passed over the gasket 34. As soon as the connecting bores 45 also pass over the gasket 34, there is no direct connection between the intermediate chamber 33 and the negative chamber 32 but only a connection via the check valve 35 so that it is no longer possible to further lower the suspension fork and a mechanical bump is avoided by the residual suspension path, as described above.

FIGS. 6 to 11 show variants of an alternative adjusting device for a suspension fork which can be adjusted to a lowered position and an extended position. As to the description of the parts not shown in the figures reference is made to the description of the exemplary embodiment which is shown in FIGS. 1 to 5 and to the technical knowledge. The reference numerals of analogous parts are increased by 100 or a multiple of 100.

In the alternative adjusting device 140 shown in FIGS. 6 and 7, an adjusting piston 170 is arranged in a cylinder 141 so as to be rotatable about its main axis. In the adjusting piston 170, a communication path 180 is formed where a valve means 150 with a check valve 151 is arranged, which may comprise a ball biased into a valve seat by means of a spring, for example. Alternative check valves known to the person skilled in the art may also be provided. In the cylinder 170, a connection 143 to a positive chamber (not shown) and a connection 144 to an intermediate chamber and/or negative chamber (not shown) are provided.

In the position of the adjusting device 140, which is shown in FIG. 6, the communication path 180 connects the connection 143 and the connection 144 such that the check valve blocks a flow from the positive chamber into the intermediate chamber and/or negative chamber and permits a flow from the negative chamber and/or intermediate chamber into the positive chamber. The suspension fork is thus placed in the extended position and/or remains in the extended position.

In the position of the adjusting device 140, which is shown in FIG. 7, the communication path 180 also connects the connection 143 with the connection 144, the adjusting piston 170 being located in a position turned by 180 degrees with respect to the position shown in FIG. 6. As a result, the blocking direction of the check valve 151 is reversed so that the check valve blocks a flow from the negative chamber and/or intermediate chamber into the positive chamber and permits a flow from the positive chamber into the intermediate chamber and/or negative chamber. As a result, the suspension fork is placed in the lowered and/or retracted position and/or remains in the lowered and/or retracted position.

FIGS. 8 and 9 show a variant of the alternative adjusting device 150 shown by way of diagram in FIGS. 6 and 7, and reference is made to the description thereof. Only the differences are described below, analogous parts being designated by equal reference numerals which are increased by 100.

In the variant shown in FIGS. 8 and 9, the cylinder 140 has two connections 143 and 144 each, which are arranged so as to reverse the blocking direction of the check valve 252 with a turn of 90 degrees.

FIGS. 10 and 11 show a variant of the alternative adjusting device 150 and/or 250 which is shown by way of diagram in FIGS. 6 and 7 and/or 8 and 9, and reference is made to the description thereof. Only the differences are described below, analogous parts being designated by equal reference number which are, however, increased by 100 or 200.

In the variant shown in FIGS. 10 and 11, the cylinder 240 has two connections 243 and 244 each, which are arranged so as to reverse the blocking direction of the check valve 252 with a turn of 45 degrees.

Other angles may be suitably chosen. The angle is preferably 20 to 160 degrees, more preferably 30 to 140 degrees, more preferably 40 to 120 degrees. In the case of designs having a mechanical remote control, smaller angles are to be preferred, e.g. 90 degrees.

As is evident, the designs shown in FIGS. 6 to 11 may comprise an axial adjustment in addition to the rotation of the adjusting piston 170, 270 and/or 270. In this case, the connections 243, 244 and/or 343, 344 must lie on different planes and/or longer connections 143 and/or 144 must be provided in axial direction in the design of FIGS. 6 and 7. Alternatively, it is also possible to provide several connections 143 and/or 144.

The suspension fork may have a remote control for actuating the actuation device 60. The remote control can have a lever having a Bowden cable, for example. In addition, a return spring can be provided whose return force is chosen such that a first threshold provided in the remote control is not overcome by the spring force. The advantage of this is that by actuation of the remote control the threshold is passed over and the actuation device can be placed in another position. At least one additional threshold may optionally be provided in the actuation device. The force of the return spring should then be high enough to ensure the passing-over of the threshold so as to be able to adjust various positions with the remote control. If the force of the return spring does not suffice to pass over the threshold in the actuation device, it is possible to adjust by means of the remote control at least one position which can be obtained against the spring force. The other position can then be set at the actuating device. Alternatively or in addition, it is possible for the remote control to also have a radio control. Such radio controls are known to the person skilled in the art.

1. A suspension fork comprising at least one positive chamber, at least one negative chamber and an adjusting device for adjusting a length of the suspension fork, with the adjusting device comprising a valve means arranged between the at least one positive chamber and the at least one negative chamber, and an actuation device,
wherein the actuation device has at least one first position for adjusting a short length of the suspension fork and at least one second position for adjusting a long length of the suspension fork.

2. A suspension fork comprising at least one positive chamber, at least one negative chamber and an adjusting device for adjusting a length of the suspension fork, with the adjusting device comprising a valve means arranged between the at least one positive chamber and the at least one negative chamber, and an actuation device, wherein the actuation device has a locking device for locking the actuation device in at least one first position and at least one second position.

3. A suspension fork comprising at least one positive chamber, at least one negative chamber and an adjusting device for adjusting a length of the suspension fork, with the adjusting device comprising a valve means arranged between the at least one positive chamber and the at least one negative chamber, and an actuation device, wherein the adjusting device has at least two communication paths for connecting the at least one positive chamber with the at least one negative chamber.

4. The suspension fork according to claim 3, wherein the adjusting device connects the at least one positive chamber with the at least one negative chamber via one of the at least two communication paths to adjust the short length of the suspension fork and connects the at least one positive chamber with the at least one negative chamber via another one of the at least two communication paths to adjust the long length of the suspension fork.

5. The suspension fork according to claim 3, wherein the adjusting device has an adjusting piston opening one of the at least two communication paths in the at least one first position of the actuation device and another one of the two communication paths in the at least one second position of the actuation device.

6. The suspension fork according to claim 5, wherein the adjusting piston is slidably arranged in a cylinder which at least partially defines the at least two communication paths between the at least one positive chamber and the at least one negative chamber.

7. The suspension fork comprising at least one positive chamber, at least one negative chamber and an adjusting device for adjusting a length of the suspension fork, with the adjusting device comprising a valve means arranged between the at least one positive chamber and the at least one negative chamber, and an actuation device, wherein the valve means has at least two check valves.

8. The suspension fork according to claim 7, wherein the at least two check valves are arranged in a chamber through which at least one communication path extends from the at least one positive chamber to the at least one negative chamber.

9. The suspension fork according to claim 7, wherein the at least two check valves have valve closure members biased by a suspension or spring means in opposite directions.

10. The suspension fork according to claim 9, wherein the suspension or spring means is arranged between the valve closure members of the at least two check valves and biases the valve closure members of the at least two check valves into respective valve seats of the at least two check valves.

11. The suspension fork according to claim 3, wherein at least one check valve is arranged in each of the at least two communication paths between the at least one positive chamber and the at least one negative chamber.

12. The suspension fork according to claim 7, wherein the at least two check valves includes at least one first check valve blocking a flow from the at least one positive chamber into the at least one negative chamber by a non-return function and includes at least one second check valve blocking a flow from the at least one negative chamber into the at least one positive chamber by a non-return function.

13. A suspension fork comprising at least one positive chamber, at least one negative chamber and an adjusting device for adjusting a length of the suspension fork, with the adjusting device comprising a valve means arranged between the at least one positive chamber and the at least one negative chamber, and an actuation device, wherein at least one communication path is arranged between the at least one positive chamber and the at least one negative chamber, and in a first position of the actuation device, the valve means opens the at least one communication path in a first direction and blocks the at least one communication path in a second direction opposed to the first direction and in a second position of the actuation device, the valve means opens the at least one communication path in the, second direction opposed to the first direction and blocks the at least one communication path in the first direction.

14. A suspension fork comprising at least one positive chamber, at least one negative chamber, an adjusting device for adjusting a length of the suspension fork, with the adjusting device comprising a valve means arranged between the at least one positive chamber and the at least one negative chamber, and an actuation device, and an intermediate chamber arranged between the at least one positive chamber and the at least one negative chamber with respect to fluid mechanics, wherein at least one communication path is arranged between the at least one negative chamber and the intermediate chamber, wherein the valve means blocks flow from the at least one negative chamber into the intermediate chamber while permitting flow from the intermediate chamber into the at least one negative chamber.

15. The suspension fork according to claim 1, wherein the actuation device has a remote control.

16. The suspension fork according to claim 15, wherein the remote control comprises a lever or a radio remote control.

17. The suspension fork according to claim 15, wherein the remote control has a locking device for locking the remote control in a first position and a second position.

18. The suspension fork according to claim 1, wherein the adjusting device has at least one further position in which the length of the suspension fork is adjusted and at least one locked position in which adjustability of the suspension fork length is blocked.

19. The suspension fork according to claim 1, wherein the actuation device has a locking device for locking the actuation device in the at least one first position and the at least one second position.

20. The suspension fork according to claim 1, wherein the adjusting device has at least two communication paths for connecting the at least one positive chamber with the at least one negative chamber.
